(19) United States
(12) Patent Application Publication
(10) Pub. No.: US 2012/0226399 A1
(43) Pub. Date: Sep. 6, 2012

(54) TRACTION CONTRO MODULE, A VEHICLE AND A METHOD OF AIDING IN CONTROLLING THE MOTION OF THE VEHICLE

(76) Inventor: Thomas Bergfjord, Upsala (SE)

(21) Appl. No.: 13/261,245

(22) PCT Filed: Sep. 28, 2010
(86) PCT No.: PCT/SE2010/051043

§ 371 Date: May 18, 2012

(30) Foreign Application Priority Data
Sep. 29, 2009 (SE) 0950706-2

(51) Int. Cl. B60W 30/02; B60W 10/184; B60W 10/08

(52) U.S. Cl. 701/22

(57) ABSTRACT

The invention relates to a traction control module (17, 35, 61, 75) for a vehicle, and a vehicle (1, 25, 51, 65) comprising the traction control module. The vehicle comprises at least one motor (3, 55, 70, 71) connected with at least one drive member (5, 27, 53, 54, 68, 69) for propulsion of the vehicle, and an accelerometer (15, 33, 59, 73) sensing the acceleration of the vehicle and generating an acceleration signal with information on the acceleration. The traction control module (17, 35, 61, 75) is adapted to receive the acceleration signal and to aid in controlling the motion of the vehicle. The invention also relates to a method of aiding with controlling the motion of a vehicle.

### CROSS REFERENCE TO RELATED APPLICATION

This application is a filing under 35 U.S.C. §371 and claims priority to international patent application number PCT/SE2010/051043 filed Sep. 28, 2010, published on Apr. 7, 2011 as WO 2011/040870, which claims priority to application number 0950706-2 filed in Sweden on Sep. 29, 2009.

### TECHNICAL FIELD

The present invention relates to a traction control module for aiding in controlling the motion of an electric vehicle. The invention further relates to a vehicle comprising such a traction control module, and a method of aiding in controlling the motion of an electric vehicle.

### PRIOR ART

Engine powered vehicles, such as boats and automobiles, travelling on an underlying material, such as a body of water or on land, may suffer from problems of controlling the motion of the vehicle due to the contact between the vehicle and the underlying material.

One such problem relates to increasing the speed of a land-based vehicle on a slippery surface, wherein the drive wheels may spin so that the vehicle fails to accelerate. One known method for alleviating this problem includes measuring the difference in wheel speed between the drive wheels and a non-driven wheel, and lowering the torque applied to the drive wheels in case a large difference is detected. A large difference in wheel speeds is thus assumed to be due to spinning. Another known method is shown in EP 0 823 348 comprising measuring two consecutive wheel speeds for a drive wheel, and assuming spinning if the difference is larger than a threshold. One problem with these methods is that there may be other reasons for the detected differences rather than spinning, and spinning may furthermore be unnoticed at higher vehicle speeds.

Another problem due to low friction relates to braking of a land-based vehicle, wherein the drive-wheels may become locked, so that the braking action is decreased. A widely used method for alleviating this problem comprises measuring the wheels speeds to detect a locked state and if so releasing the braking action temporarily. A more elaborate variant of this method is shown in patent document U.S. Pat. No. 5,511,866, which also includes rotating a drive wheel at a target wheel speed after release of the brake.

Yet another problem due to low friction comprises sliding of the vehicle when turning the vehicle in a curve. One method of alleviating this problem for a land-based automobile comprises detecting a possible under- or oversteering of the vehicle with an accelerometer, and selectively braking one or more wheels to create a torque forcing the vehicle back into the desired curve.

One problem for water-based vehicles is that undercurrents, waves or tides may affect the motion of the boat so that the boat acquires a non-desired travelling path.

### SUMMARY OF THE INVENTION

One object of the present invention is to indicate how to even further improve the control of the motion of a vehicle.

According to a first aspect of the invention this object is achieved with the traction control module according to claim 1.

According to a second aspect of the invention this object is also achieved with the electric vehicle according to claim 8.

According to a third aspect of the invention this object is also achieved with the method according to claim 10.

By measuring the acceleration of the vehicle with an accelerometer in combination with inducing at least one electric motor to modify the power to at least one drive member based on the measured acceleration, it is possible to affect and control the motion of the vehicle in a more sophisticated and effective manner. Instead of relying only on indirect measurements of the motion, such as on wheel speeds, requiring more or less correct assumptions in order to estimate the actual motion of the vehicle, the invention incorporates an accelerometer so that the actual motion may be determined more directly and accurately. By modifying the power of at least one electric motor and delivered to at least one drive member based on the measured acceleration, it is furthermore possible to affect the motion of the vehicle in new and more efficient ways as described hereinafter, improving the performance, control and safety of driving the vehicle. Preferably, the vehicle comprises two electric motors, each providing power to one drive member. Hence each drive member may be individually and independently controlled.

The accelerometer is preferably a sensor having the ability to detect or react to changes in force acting on the accelerometer. The accelerometer may comprise a movable body or member, wherein the displacement of the body gives an indication of force. A signal indicating the acceleration may be given in any appropriate form, but is preferably an electronic signal. The accelerometer may sense the acceleration in one dimension, but is preferably arranged to sense the acceleration in at least two dimensions, preferably in three dimensions. Preferably the accelerometer is further adapted to sense a rate of change in rotation about at least one rotational axis. Preferably the accelerometer is adapted to sense a rate of change in rotation about three rotational axes.

The acceleration of a vehicle as measured by the accelerometer is the response to the sum of the forces acting on the vehicle. The acceleration may thus be in any direction, including the forward, backward and sideway direction, such as when driving in a curve, and may also include rotational acceleration. Acceleration thus includes both an increase in speed, and also a decrease in speed, or deceleration, for the vehicle.

The electric vehicle may be a water- and/or a land-based vehicle. In case of a water-based vehicle the drive-member may be a propeller, and the vehicle may comprise one, but preferably two or more, propellers. In case of a land-based vehicle the drive member may be a wheel, and the vehicle may comprise two, but preferably three or more wheels. Preferably, at least two, but possibly four, wheels are drive wheels. Preferably the vehicle is furthermore designed for travel on roads, preferably on public roads. Preferably, the land based vehicle is an automobile, a lorry, a truck or a bus. The traction control module may be realised in hardware, software or a combination of the two. The traction control module may be a separate unit, or may be a part of a larger control system for the vehicle.

According to one embodiment the traction control module is also adapted to receive information pertaining to an expected motion for the vehicle. The expected motion of the vehicle is the motion expected during normal driving conditions departing from driving impulses given by a driver, a driving computer or the like, disregarding irregularities or influences from the underlying material or wind. The information pertaining to the expected motion may include or, be derived from information on said driving impulses, such as braking, input from an accelerator pedal, and steering input, and/ or information based on the adjustment or measurement from components in the vehicle, such as the angle of a steering wheel or rudder, and drive wheel or propeller speed and acceleration. The traction control module may then be adapted to calculate the required information on the expected motion from said signals, or the traction control module may receive already processed information on the expected motion from another module, in whole or in part. Preferably, the information on the expected motion includes information on the expected acceleration. Thus a direct comparison between the expected motion and the acceleration signal from the accelerometer can be made.

According to one embodiment the traction module is further adapted to estimate a discrepancy between the expected motion and an actual motion of the vehicle based on the received acceleration signal. Hence any inconsistencies, irregularities of the underlying material, faulty conditions, failures, or similar, may easily and reliably be detected.

According to one embodiment the traction module is also adapted to induce the at least one electric motor to modify the power to at least one drive member in order to minimize the discrepancy. According to a further embodiment the traction module is also adapted to induce the at least one electric motor to increase the power to at least one drive member in order to minimize the discrepancy. Preferably, the traction control module is adapted to perform a continuous control loop aiming at minimizing the discrepancy. Hence a control method for the motion of the vehicle is achieved, which aim at decreasing and minimizing any difference between the actual motion and the motion desired by a driver. Hence there is provided a better flexibility in the control of the vehicle performed by the traction control module, and there is less, or even no need for fixed rules on how to detect or address a certain situation, which is often the case in the prior art and which may give erroneous results depending on circumstances.

According to a further embodiment the traction control module is adapted to estimate a rate of change in said discrepancy, and to induce the at least one electric motor to modify or increase the power to the at least one drive member based on the estimated change. Preferably the traction control module is adapted to estimate or calculate the rate of change in said discrepancy over time. In one embodiment, the rate of change in discrepancy is calculated by comparing two or more consecutive values according to a mathematical algorithm. Hence, an even better and more finely tuned method for control is achieved, which may indentify and correctly address even more situations that may occur while driving the vehicle. By using the information on the rate of change of the discrepancy identification of whether the power generated by the electric motors should be increased or decreased in order to minimize the discrepancy is simplified.

According to one embodiment the traction control module is adapted to generate a control signal inducing at least one electric motor to increase the power to at least one drive member based on the received acceleration signal. This gives a powerful method of controlling the motion. Furthermore the increase may be carried out automatically and almost unnoticed by a driver of the vehicle. An increase in power also allows an improved control of the vehicle in a greater variety of situations. According to one embodiment the traction control module may also be adapted to generate a control signal inducing at least one electric motor to decrease the power to at least one drive member based on the received acceleration signal. Hence, in case a small decrease only is desired, there is no need

According to one embodiment, during a braking of the vehicle, the traction control module is adapted to influence an anti-locking device to retain a locked state for a drive member based on the received acceleration signal. Preferably, the traction control module is adapted to influence an anti-locking device to retain a locked state for a drive member in case the discrepancy between a measured deceleration from the acceleration signal and an expected deceleration is below a threshold limit. Preferably, the traction control module is adapted to influence an anti-locking device to retain a locked state for a drive member if the accelerometer signals that the measured deceleration remains above a threshold. The threshold may be a percentage of a maximum deceleration measured during the braking action or some other suitable value. In some circumstances, for example if the ground is soft, a shorter braking distance may be achieved with a locked wheel rather than an intermittently braked wheel. This is due to that the wheel may dig down into the ground. Based on the signals from the accelerometer, it is possible to discern if a locked wheel or a turning wheel gives the shortest stopping distance.

According to one embodiment, during a braking of the vehicle, the traction control module is adapted to influence at least one electric motor to increase power to at least one drive member based on the acceleration signal after a temporary ceasing of the braking action to avoid locking of the drive member. In case of ceasing the braking operation to unlock a previously locked drive member, such as a wheel, the wheel is either rotating at a very low speed or not at all. By increasing power to the drive member the drive member will more quickly reach the speed corresponding to the relative speed of the underlying ground, so that the braking action may be resumed more quickly.

According to one embodiment the traction control module is adapted to estimate an applied braking force torque at which point a wheel becomes locked and begins to slip on the ground. The traction control module may estimate this point from historic measurement values of a previous locking of the drive member. Preferably, the traction member is also adapted to limit the braking power to remain below said point to avoid a second locking of the wheel.

According to one embodiment, when increasing the speed of the vehicle, the traction control module is adapted to induce an electric motor to decrease the power to a drive member in case the measured acceleration of the vehicle is below an expected acceleration. By including an accelerometer a loss of traction for a wheel can easily be detected. By decreasing the power from the electric motor to the wheel it will reduce its speed, so that the wheel will stop spinning and regain traction so as to provide the necessary force to drive the vehicle forward or backward. Preferably the traction control module decreases the power to the wheels individually, wherein if one wheel looses traction the other wheels may still deliver a high torque.

According to one embodiment, when increasing the speed of the vehicle from standstill, the traction control module is adapted to induce at least one electric motor to alternately reverse and forward the action of a drive member based on the acceleration signal. When starting a land-based vehicle standing on soft and slippery ground, such as earth, sand or mud, there is a tendency for a wheel to dig down in the material if it spins. By controlling the electric motor to alternately reverse and forward the power based on the acceleration signal it may be possible to rock the vehicle back and forth until there is sufficient kinetic energy to let the vehicle and the drive wheel get out of the depression.

According to one embodiment, during a turning of the vehicle, the traction control module is adapted to induce an electric motor to increase power to a drive member to achieve a corrective torque based on an estimated discrepancy between the vehicles movement direction and an expected movement direction. Hence the motion of the vehicle is corrected so as to follow a desired, or expected, path, even if there is a tendency for over-steering or under-steering. Furthermore, the corrective torque may also aid in case the vehicle skids. Possibly, the traction control module may simultaneously induce a reduction in the power generated to and/or a regenerative braking of separately brake a second drive member located on the other side of a pivot point for the corrective torque 74. Hence the corrective torque will be created by two drive members acting in opposite directions on either side of the pivot point.

### BRIEF DESCRIPTION OF THE ATTACHED DRAWINGS

The invention is now to be described as a number of non-limiting examples of the invention with reference to the attached drawings.

FIG. 1 shows a vehicle in the form of an automobile provided with an accelerometer and a traction control module.

FIG. 2 shows a diagram of a method of aiding in controlling the motion of the vehicle performed by the traction control module in FIG. 1.

FIG. 3a shows a vehicle comprising a drive member in the form of a drive wheel on soft ground.

FIG. 3b shows a vehicle comprising a drive member in the form of a drive wheel on hard ground.

FIG. 4a shows a diagram of the deceleration of a vehicle on soft ground when using a control method according to one example of the invention.

FIG. 4b shows a diagram of the deceleration of a vehicle on hard ground when using a control method according to one example of the invention.

FIG. 4c shows a diagram of the generated power, expected acceleration, acceleration signal and discrepancy when increasing the speed of a vehicle on hard ground with low friction.

FIG. 4d shows a diagram of the generated power and the acceleration signal when starting a vehicle from standstill on soft ground.

FIG. 4e shows a vehicle in the form of an automobile provided with an accelerometer and a traction control module providing aid in controlling the motion of the vehicle when turning.

FIG. 4f shows a vehicle in the form of a boat provided with an accelerometer and a traction control module providing aid in controlling the motion of the vehicle when turning.

### DETAILED DESCRIPTION

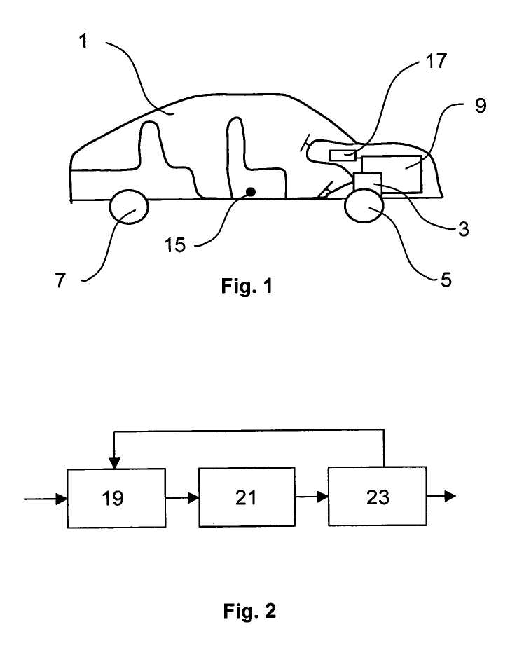

In FIG. 1 an electric vehicle 1 in the form of an electric automobile is shown. The vehicle 1 comprises two electric motors 3 and two drive members 5 in the form of two drive wheels. The electric motors 3 and drive wheels 5 are positioned on either side of the vehicle, and each electric motor is arranged to provide propulsion energy to one drive wheel individually, which improves the possibilities for control. The vehicle 1 further comprises two non-driven wheels 7, and a battery pack 9 for powering the electric motors. The vehicle further comprises a braking device (not shown) having brakes for decelerating the vehicle, and an anti-locking device (not shown), arranged to interrupt a braking operation in case a wheel becomes locked.

The electric vehicle further comprises an accelerometer 15 arranged to sense the acceleration of the vehicle. The accelerometer 15 is arranged to sense a force acting on the accelerometer. The design of such accelerometers is known in the art, and typically, the accelerometer comprises an internal body whose position or movement is dependent on the external forces acting on the accelerometer. The accelerometer 15 is further arranged to generate an acceleration signal in response to said forces. In this example the accelerometer is arranged to detect the acceleration in three different and perpendicular directions, but an accelerometer sensing the acceleration in only one or in two directions could in some cases also be used. The accelerometer may further be adapted to sense a rate of change in rotation of the vehicle around one or more rotation axes, for example to simplify detection of a turning of the vehicle.

The vehicle further comprises a traction control module 17 adapted to receive the acceleration signal from the accelerometer, and to aid in controlling the motion of the vehicle. For this purpose the traction control module 17 is adapted to generate a control signal influencing the operation of one or more components of the vehicle that may affect the motion of the vehicle. In this example the traction control module 17 is adapted to generate a control signal inducing an electric motor 3 to modify the power to a drive member 5 based on the received acceleration signal. Since, in this example, the electric motors 3 are arranged to power one drive member 5 each, the drive members 5 may be individually, separately and independently controlled and/or influenced by the traction control module 17. Thus an improved control is achieved so that the traction control module 17 may aid in controlling the motion of the vehicle 1 in a more sophisticated, and more finely tuned, manner. This may in turn result in better performance for the electric vehicle.

In this example the traction control module 17 is further adapted to generate a control signal inducing at least one electric motor 3 to increase the power to at least one drive member 5 based on the received acceleration signal. Hence, the traction control module 17 provides for an enhanced control of the motion in situations in which an increase of power to only one or a few drive members is advantageous. In this example the traction control module 17 is also arranged to generate a control signal for inducing an electric motor to decrease the power to at least one drive member based on the received acceleration signal. The traction control module may also be arranged to influence the amount of regenerative braking if provided. The traction control module may also influence other components affecting the motion of the vehicle, such as steering members, the braking device 11, the anti-locking device 13, or other components.

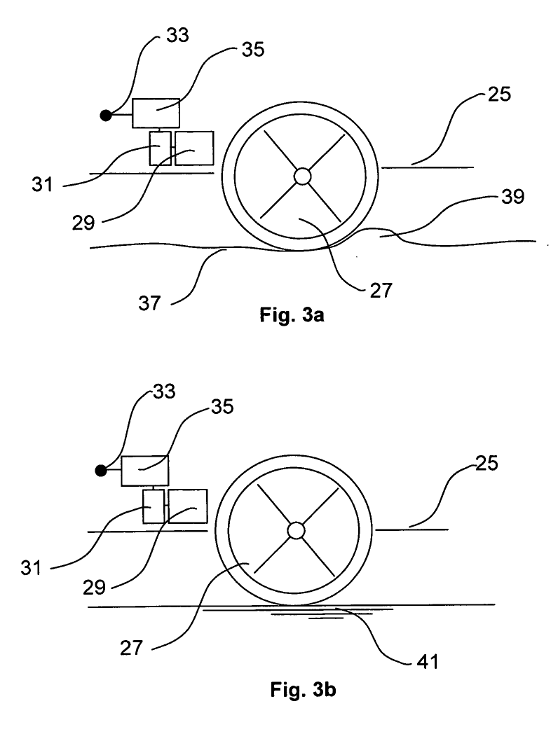

In FIG. 2 a method for aiding in controlling the motion of the vehicle 1 in FIG. 1 according to one example of the invention is shown. In this example the method comprises a control loop which is repeated continuously while driving the vehicle, and which comprises:

A first step 19 in which the traction control module 17 is adapted to receive information pertaining to an expected motion for the vehicle 1. The information may for example contain information on wheel speeds obtained from wheel sensors, and steering angel obtained from a steering angle sensor. The information may also include information on a desired increase in speed for the vehicle, for example departing from the depression of an accelerator pedal by an operator. The traction control module is further arranged to estimate the expected (or desired) motion departing from the received information. Alternatively, the expected motion may be determined elsewhere and then be transmitted to the traction control module.

In a second step 21 the traction control module is adapted to receive the acceleration signal from the accelerometer. The traction control module 17 is further arranged to estimate a discrepancy between the expected motion and an actual motion of the vehicle based on the received acceleration signal. In this example, the expected motion is given in the form of an expected acceleration, wherein the discrepancy is estimated by direct comparison of the expected acceleration and the measured acceleration. The traction control module 17 is furthermore arranged to estimate a rate of change of the discrepancy, by comparing data on the discrepancy at different points of time.

In a third step 23 the traction control module 17 is adapted to induce the at least one electric motor 3 to modify the power to at least one drive member 5 in order to minimize the discrepancy. In this example the traction control module 17 is adapted to modify the power to each drive member 5 individually. The modification of the power may include any or a combination of increasing the power to a drive member, decreasing the power to a drive member, inducing or reducing regenerative braking and inducing or reducing mechanical braking.

The traction control module 17 is further arranged to modify the power to at least one drive member based on the rate of change in said discrepancy over time. In this example the traction control is adapted to modify the power to the at least one drive member 5 based on other input signals as well, such as the wheel speeds, wheel accelerations (for example based on the measurements of wheel speeds), temperature, etc, to even further improve of the control. For example, these signals may be used to foretell in which manner the power should be modified, and to help discern between different driving situations.

The control method is then repeated by returning to the first step 19. By providing a control loop directed towards obtaining an optimized (or minimized) value in discrepancy, the control of the motion of the vehicle becomes more flexible and may account for more situations without resorting to crude control rules which may or may not be appropriate for a particular situation. Furthermore, in case a certain manner of control is proven ineffective, this will be noted from the estimation of the discrepancy and of the rate of change of the discrepancy, so that an alternative manner of control may be selected instead.

In the following a number of examples of common situations which may be resolved with the vehicle, traction control module and method according to the invention will be shown.

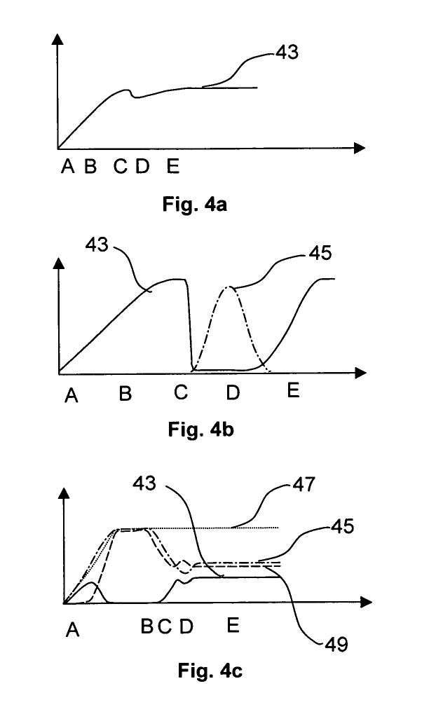

In FIGS. 3a and 3b, a vehicle 25 comprising a drive wheel 27 powered by an electric motor (not shown), a braking device 29, an anti-locking device 31, an accelerometer 33 and a traction control module 35 is shown standing on grounds of different constitution. In FIG. 3a the vehicle is standing on soft ground 37, wherein the material has the ability to move underneath the wheel, giving a low friction, but also having the ability to pile up 39. Examples include mud, sand, earth, gravel and snow. In FIG. 3b the vehicle is standing on hard ground 41 which may have for example a high friction, such as asphalt, or a low friction, such as ice.

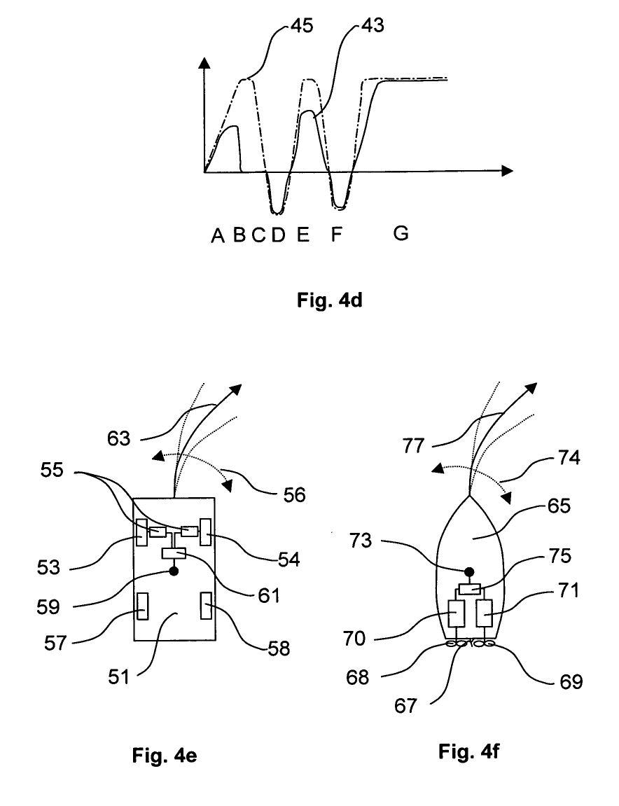

In FIG. 4a a diagram of the deceleration 43 of a vehicle on soft ground 37 when braking is shown. The braking action is applied at time (A), at which the braking action is low and is entirely due to regenerative braking. The braking action is then increased, and at a higher level of braking (B) the braking device applies mechanical brakes. At an even higher braking action (C) the friction between the ground and the wheel is insufficient to continue to turn the wheel and the wheel locks. However, due to the pile-up of material 39 in front of the wheel, the accelerometer 33 senses that the deceleration drops only very slightly (D), and then continues at a high level (E) as even more material builds-up. Hence the traction control module 35 is adapted to induce the anti-locking device 31 to retain the locked state for the wheel based on the received acceleration signal, giving a shorter braking distance.

In FIG. 4b a diagram shows the power 45 generated by an electric motor to a drive wheel and the deceleration 43 when the vehicle is braking on hard ground with low friction. The diagram and events is similar to the diagram in FIG. 4a for events (A)-(C). At [C] the wheel becomes locked, meaning that the friction between the wheel and the underlying material decreases substantially due to slipping of the wheel. The anti-locking device 31 then steps in and releases the brakes. The accelerometer simultaneously detects a discrepancy between the expected deceleration and the actual deceleration, and at (D) the traction control module induces the electric motor to increase the power 45 to the wheel. The traction control module is further adapted to calculate the present speed of the vehicle based on the acceleration signal, and controls the electric motor to drive the wheel to rotate with the same, or a slightly lower speed. When the wheel speed increases to the former speed (E) the traction control module induces the electric motor to cease driving the drive member and the anti-locking device 31 induces the brakes to resume braking so as to further decelerate the vehicle. Hence the time until the wheel speed increases so that the brakes may be reapplied is decreased due to the increase in power, in difference to when the wheel is reaccelerated only through contact with the ground, wherein the braking distance may be shortened.

In FIG. 4c a diagram shows one example of the power 45 generated by an electric motor to a drive wheel when increasing the speed of the vehicle when being on hard ground with low friction. At (A) the electric motors generate a power for accelerating the vehicle. The expected acceleration 47 is then proportional to the generated power. However, due to the low friction, the wheels spin so that there is a very low resultant driving force. The accelerometer measures no acceleration 43, and the traction control module detects a discrepancy 49 between the actual acceleration 43 and the expected acceleration 47. At (B) the traction control module is adapted to induce the electric motors to decrease the power to the drive wheels in response to the discrepancy. The power 45 is reduced until the wheels stops spinning and accelerates the vehicle (C), at which point the accelerometer detects the acceleration. Hence the discrepancy 49 between the actual motion (sensed acceleration) and the expected motion (based on the desired power, not the reduced power) begins to drop and then reaches a minimum (D), after which a further reduction in power lessens the acceleration as normally expected. The traction control module detects the discrepancy based on the acceleration, and minimizes the discrepancy 49 by maintaining the present, optimum power 45, shown at (E).

In FIG. 4d a diagram shows one example of the power 45 generated by an electric motor to a drive wheel when the vehicle is started on soft ground. At (A) the electric motors generate power for increasing the speed of the vehicle. However, due to the soft ground, the drive wheels spin so that there is a very low resultant driving force, and also dig down in the ground creating a depression. The accelerometer then measures no acceleration 43 at (B), and the traction control module thus detects a discrepancy between the actual acceleration and the expected acceleration. At (C) the traction control module is adapted to induce the electric motors to decrease the power to the drive wheels in response to the discrepancy. The torque is reduced until the wheels stops spinning and accelerates the vehicle, at which point the accelerometer detects the acceleration 43. However, due to the depression, the kinetic energy is insufficient to let the vehicle accelerate any further. The accelerometer senses the movement in the vertical direction, and the traction control reverses the torque in response (D). The vehicle rocks backwards, and when the vehicle comes to a halt, once again due to lack of kinetic energy, alternatively due to that the accelerometer senses a sufficient vertical movement at the other end of the depression, the traction control module forwards the power (E). In case the joint kinetic energy from potential energy and driving force is now sufficient to overcome the height of the depression, the vehicle becomes free to move. In case there is still not sufficient kinetic energy to free the vehicle, the process may instead be repeated (F), until the kinetic energy becomes sufficient and the vehicle may move forward (G). In this example the vehicle further comprises an inclination sensor indicating the vehicle inclination of the vehicle, so as to ensure that the vertical acceleration is due to a depression and not due to that the vehicle is simply standing on inclining ground.

In FIG. 4e a land-based vehicle 51 comprising a frame, two drive wheels 53, 54 powered by two electric motors 55, two non-driven wheels 57, 58, an accelerometer 59 and a traction control module 61 is shown. A driver operates the vehicle 51 with the aim of steering the vehicle according to the marked travelling path 63. However, due to low-friction, irregularities in the ground, strong winds, unevenly inflated tyres or other reasons, the vehicle may be prone to follow an over-steered course, or an under-steered course.

The accelerometer 59 senses the acceleration of the vehicle, and the traction control module 61 detects the discrepancy between the actual motion and the expected motion 63 during the turning of the vehicle. The traction control module 61 is then adapted to induce an electric motor 55 to increase power to a drive wheel 53, 54 to achieve a corrective torque 56 based on the estimated discrepancy between the vehicles movement direction and the expected movement direction. The traction control module 61 is furthermore adapted to induce a decreasing speed or braking action for a wheel located on the other side of the pivotal point for the corrective torque, either by lowering the power and torque and/or regenerative braking of a drive wheel, and/or by mechanical braking of a drive wheel and/ or non-driven wheel.

In this example, in case of under-steering, the traction control module increases the power to the drive wheel 54, reduces the power to drive wheel 53, and brakes the non-driven wheel 58. In case of over-steering, the traction control module increases the power to the drive wheel 53, reduces the power to drive wheel 54, and brakes the non-driven wheel 57.

In FIG. 4f a vehicle in the form of a boat 65 comprising a hull, a rudder 67, two propellers 68, 69 driven by two electric motors 70, 71, an accelerometer 73 and a traction control module 75 is shown. A driver operates the vehicle with the aim of steering the vehicle according to the marked travelling path 77. However, due to currents, waves, wind, tides or other reasons, the vehicle may be prone to follow an over-steered course, or an under-steered course. The traction control module 75 is then adapted to induce an electric motor 70, 71 to automatically modify the power to a propeller 68, 69 to achieve a corrective torque 74 based on the estimated discrepancy between the vehicles movement direction and the expected movement direction. In this example, in case of under-steering, the traction control module induces the electric motor 69 to increase the power, and the electric motor 68 to reduce the power. In case of over-steering the power modification is the opposite.

The invention is not limited by the examples and embodiments shown, but may be varied freely within the framework of the following claims. In particular the features of different examples and embodiments may be combined to form new embodiments, and features in the examples may be added, removed or interchanged without departing from the scope of the invention as defined in the claims.

1. A traction control module for a vehicle, the vehicle (1, 25, 51, 65) comprising at least one motor (3, 55, 70, 71) connected with at least one drive member (5. 27, 53, 54, 68, 69) for propulsion of the vehicle, and an accelerometer (15, 33, 59, 73) sensing the acceleration of the vehicle and generating an acceleration signal with information on the acceleration, wherein the traction control module (17, 35, 61, 75) is adapted to receive the acceleration signal and to aid in controlling the motion of the vehicle, wherein the vehicle is an electric vehicle (1, 25, 51, 65) and the at least one motor is an electric motor (3, 55, 70, 71), wherein the traction control module (17, 35, 61, 75) is adapted to generate a control signal inducing at least one electric motor to modify the power to at least one drive member based on the received acceleration signal.

2. The traction control module of claim 1, wherein the traction control module (17, 35, 61, 75) is adapted to receive information pertaining to an expected motion (47, 63, 77) for the vehicle, to estimate a discrepancy (49) between the expected motion and an actual motion of the vehicle based on the received acceleration signal, and to induce the at least one electric motor to modify the power to at least one drive member in order to minimize the discrepancy.

3. The traction control module of claim 2, wherein the traction control module (17, 35, 61, 75) is adapted to estimate a rate of change of said discrepancy, and to induce the at least one electric motor to modify the power to the at least one drive member based on the estimated rate of change.

4. The traction control module of claim 1, wherein the traction control module (17, 35, 61, 75) is adapted to generate a control signal inducing at least one electric motor to increase the power to at least one drive member based on the received acceleration signal.

5. The traction control module of claim 1, wherein, during a braking of the vehicle, the traction control module (17, 35, 61, 75) is adapted to influence an anti-locking device (31) to retain a locked state for a drive member based on the received acceleration signal.

6. The traction control module of claim 1, wherein, during a braking of the vehicle, the traction control module (17, 35, 61, 75) is adapted to influence at least one electric motor to increase power to at least one drive member based on the acceleration signal after a temporary ceasing of the braking action to avoid locking of the drive member.

7. The traction control module of claim 1, wherein, when increasing the speed of the vehicle, the traction control module (17, 35, 61, 75) is adapted to induce an electric motor to decrease the power to a drive member in case the measured vehicle acceleration of the vehicle is below an expected acceleration.

8. The traction control module of claim 1, wherein, during a turning of the vehicle, the traction control module (17, 35, 61, 75) is adapted to induce an electric motor to increase the power to a drive member to achieve a corrective torque based on an estimated discrepancy between a movement direction of the vehicle and an expected movement direction (63, 77) for the vehicle.

9. A vehicle comprising a motor connected with at least one drive member for propulsion of the vehicle, an accelerometer (15, 33, 59, 73) sensing the acceleration of the vehicle and generating an acceleration signal with information on the acceleration, and a traction control module (17, 35, 61, 75) adapted to receive the acceleration signal and to aid in controlling the motion of the vehicle, wherein the vehicle is an electric vehicle and the at least one motor is an electric motor, wherein the vehicle comprises the traction control module of claim 1.

10. The electric vehicle of claim 9, wherein the electric vehicle is a land based vehicle intended for public roads, and further wherein the drive member comprises a drive wheel.

11. A method of controlling an electric vehicle comprising an electric motor connected with at least one drive member for propulsion of the vehicle, an accelerometer (15, 33, 59, 73) sensing the acceleration of the vehicle and generating an acceleration signal with information on the acceleration, and a traction control module (17, 35, 61, 75) adapted to receive the acceleration signal and to aid in controlling the motion of the vehicle, the method comprising
receiving the acceleration signal in the traction control module, and
generating a control signal inducing at least one electric motor to modify the power to at least one drive member based on the received acceleration signal.
